(19) United States
(12) Patent Application Publication
(10) Pub. No.: US 2026/0120978 A1
(43) Pub. Date: Apr. 30, 2026

(54) KEY SWITCH ASSEMBLY, KEYBOARD AND CONSOLE DEVICE

(71) Applicant: FCL COMPONENTS LIMITED, Tokyo (JP)

(72) Inventors: Akihiko ARIKAWA, Tokyo (JP); Takeshi NISHINO, Tokyo (JP)

(73) Assignee: FCL COMPONENTS LIMITED, Tokyo (JP)

(21) Appl. No.: 19/369,684

(22) Filed: Oct. 27, 2025

(30) Foreign Application Priority Data
Oct. 28, 2024 (JP) 2024-189141

(51) Int. Cl. H01H 13/14; H01H 13/70

(52) U.S. Cl. CPC H01H 13/14; H01H 13/70; H01H 2235/01

(57) ABSTRACT

A key switch assembly includes a sliding member that is slidable by pressing of an operation member, a support member having a guide that guides the sliding member, a first elastic member provided between the sliding member and the support member, the first elastic member generating a repulsive force against a force pressing the operation member, a second elastic member that is attached to the sliding member, and an electrical contact disposed so as to have an air gap between the electrical contact and the second elastic member in a state before the operation member is pressed, the electrical contact being opened and closed by the second elastic member in accordance with sliding of the sliding member, wherein a spring constant of the second elastic member is larger than a spring constant of the first elastic member.

### CROSS-REFERENCE TO RELATED APPLICATION

This application is based upon and claims the benefit of priority of the prior Japanese Patent Application No. 2024-189141 filed on Oct. 28, 2024, the entire contents of which are incorporated herein by reference.

### FIELD

A certain aspect of the embodiments is related to a key switch assembly, a keyboard and a console device.

### BACKGROUND

The key switch assemblies can be classified into a key switch assembly that provides a click sensation to a user and another key switch assembly that provides a linear sensation without a click sensation to a user.

The click sensation is a sensation as if the key top is pulled in when an operation force required to push the key top is rapidly reduced due to buckling deformation of rubber or the like. On the other hand, the linear sensation is a sensation corresponding to a repulsive force of the spring proportional to the operation force. Note that the technique related to the present disclosure is disclosed in Japanese Laid-open Patent Publication No. 2011-249282, and Japanese Laid-Open Utility Model Publication No. H03-057832.

### SUMMARY

According to an aspect of the present disclosure, there is provided a key switch assembly including: a sliding member that is slidable by pressing of an operation member; a support member having a guide that guides the sliding member; a first elastic member provided between the sliding member and the support member, the first elastic member generating a repulsive force against a force pressing the operation member; a second elastic member that is attached to the sliding member; and an electrical contact disposed so as to have an air gap between the electrical contact and the second elastic member in a state before the operation member is pressed, the electrical contact being opened and closed by the second elastic member in accordance with sliding of the sliding member; wherein a spring constant of the second elastic member is larger than a spring constant of the first elastic member.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF THE DRAWINGS

FIG. 1A is a perspective view of a keyboard according to an embodiment.

FIG. 1B is a perspective view of a console device having the keyboard according to the present embodiment.

FIG. 2A is an exploded perspective view illustrating each component of a key switch assembly.

FIG. 2B is a side view of the key switch assembly.

FIG. 3A is a plan view illustrating the front side of a key top.

FIG. 3B is a cross-sectional view taken along a line A-A of FIG. 3A.

FIG. 3C is a cross-sectional view taken along a line B-B of FIG. 3A.

FIG. 3D is a plan view illustrating the back side of the key top.

FIG. 4A is a plan view of a slider as viewed from above.

FIG. 4B is a cross-sectional view taken along a line A-A of FIG. 4A.

FIG. 4C is a cross-sectional view taken along a line B-B of FIG. 4A.

FIG. 4D is a perspective view of the slider.

FIG. 5A is a plan view of a housing as viewed from above.

FIG. 5B is a cross-sectional view taken along a line A-A of FIG. 5A.

FIG. 5C is a cross-sectional view taken along a line B-B of FIG. 5A.

FIG. 5D is a perspective view of the housing.

FIG. 6A is a plan view of the key switch assembly as viewed from above.

FIG. 6B is a cross-sectional view taken along a line A-A of FIG. 6A.

FIG. 6C is a cross-sectional view taken along a line B-B of FIG. 6A.

FIG. 6D is an enlarged view of a lower portion of the key switch assembly.

FIG. 7A is a diagram illustrating a depression characteristic of a conical spring.

FIG. 7B is a diagram illustrating a depression characteristic of a spring.

FIG. 7C is a diagram illustrating a depression characteristic of the key switch assembly in which depression characteristics of the conical spring and the spring are combined.

FIG. 8A is a cross-sectional view of the key switch assembly having a printed circuit board.

FIG. 8B is a plan view illustrating a positional relationship between a spring, and a first contact and a second contact.

FIG. 9A is a block diagram illustrating a connection relation between the printed circuit board and a computer.

FIG. 9B is a circuit diagram of a keyboard controller and a switch matrix included in the printed circuit board.

### DESCRIPTION OF EMBODIMENTS

The key switch assembly with the linear sensation cannot provide a click sensation to the user. Therefore, the user can recognize that the electrical contact of the key switch assembly is turned on by viewing the input contents on an operation screen. However, the user cannot recognize that the electrical contact of the key switch assembly is turned on only by the sensation without viewing the input contents on the operation screen.

The present disclosure provides a key switch assembly, a keyboard and a console device capable of providing a linear sensation to a user and making the user recognize an ON state of the electric contact only by the sensation.

According to an aspect of the present disclosure, it is possible to provide a linear sensation to a user and make the user recognize the ON state of the electrical contact only by the sensation.

Hereinafter, embodiments of the present disclosure will be described with reference to the drawings.

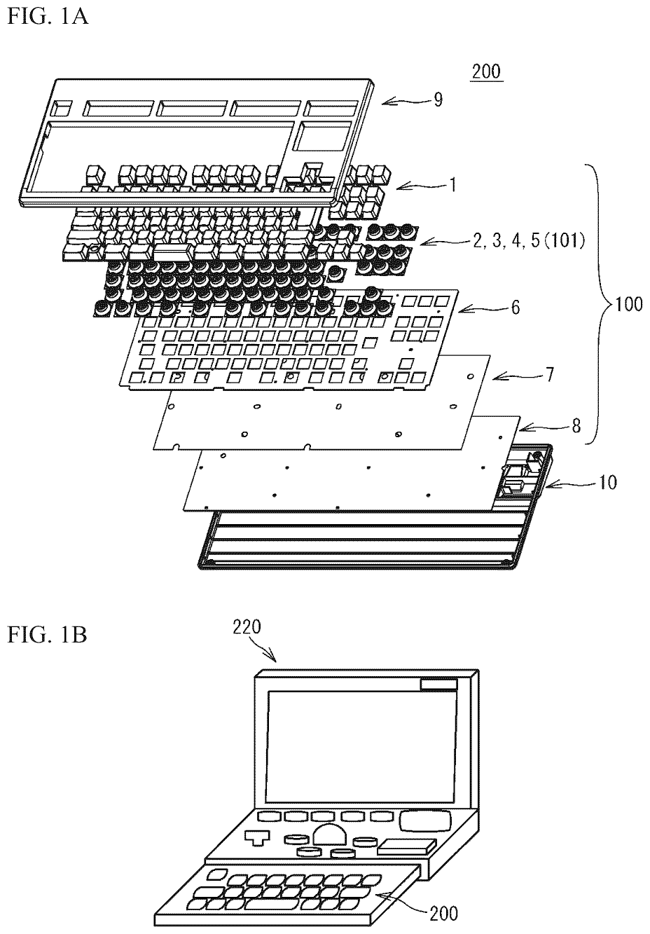

FIG. 1A is a perspective view of a keyboard according to the present embodiment. FIG. 1B is a perspective view of a console device having the keyboard according to the present embodiment.

As illustrated in FIG. 1A, a keyboard 200 includes an upper cover 9, a lower cover 10, and a key switch assembly 100. The key switch assembly 100 includes a key top 1 (operation member), a slider 2 (sliding member), a conical spring 3 (first elastic member), a spring 4 (second elastic member), a housing 5 (support member), a switch panel 6, a membrane sheet 7, and a circuit board 8. The slider 2, the conical spring 3, the spring 4, and the housing 5 constitute a switch unit 101. In the keyboard 200, the switch panel 6, the membrane sheet 7, and the circuit board 8 in the key switch assembly 100 are formed to be enlarged in the horizontal direction over the entire keyboard, and are shared by the plurality of switch units 101.

As illustrated in FIG. 1B, a console device 220 such as a machine tool, a medical device, a ticket machine, an ATM, or a kiosk terminal may include the keyboard 200 according to the present embodiment as an input device.

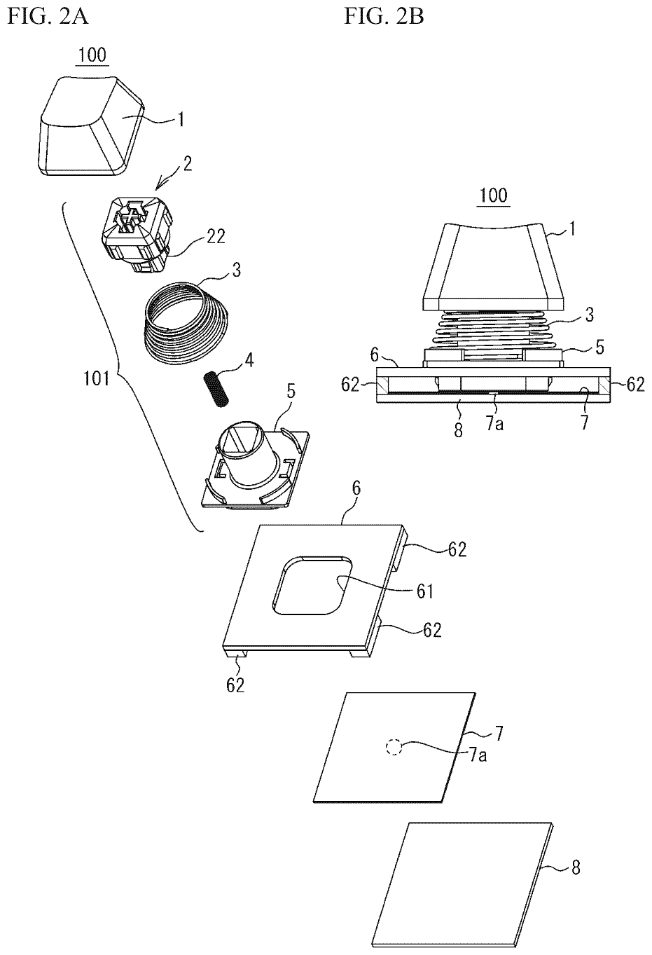

FIG. 2A is an exploded perspective view illustrating each component of the key switch assembly 100, and FIG. 2B is a side view of the key switch assembly 100.

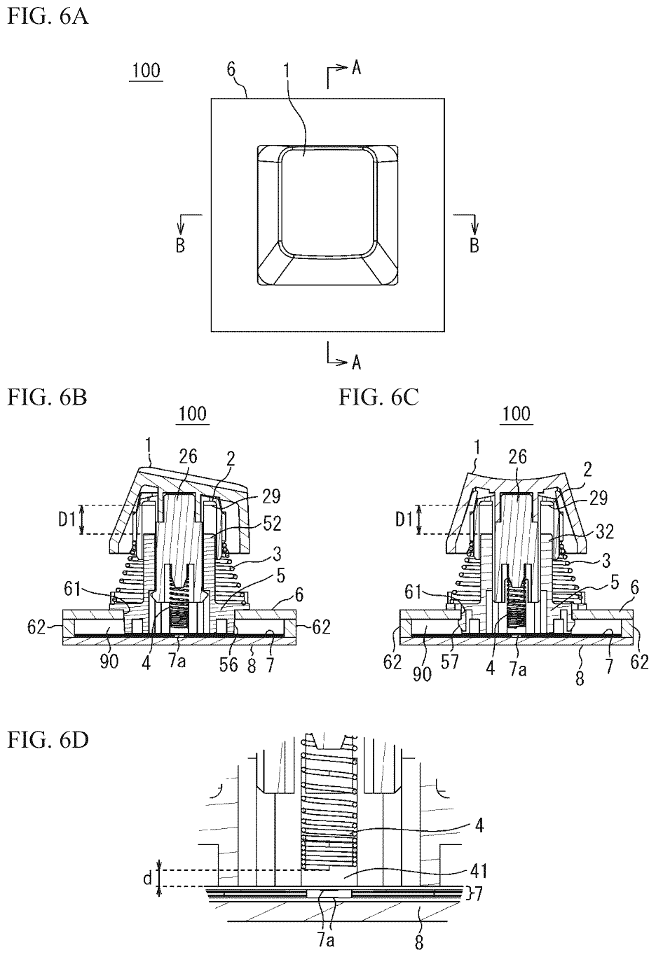

The key switch assembly 100 of FIG. 2A includes the slider 2 to which the key top 1 can be attached and which can slide by pressing down the key top 1, the conical spring 3 that is provided between the slider 2 and the housing 5 and generates a repulsive force against a force pressing the key top 1, the spring 4 that is attached to the slider 2 and presses an electrical contact 7a, and the housing 5 to which the slider 2 is attached and which guides the sliding of the slider 2 in the vertical direction. The key switch assembly 100 further includes the switch panel 6 that is a positioning member for positioning the housing 5, the membrane sheet 7 that is disposed under the housing 5 and the switch panel 6, includes the electrical contacts 7a, has an air gap 41 (see FIG. 6D) between the membrane sheet 7 and the spring 4, and is pressed down by the spring 4 in accordance with the sliding of the slider 2, and the circuit board 8 that is disposed under the membrane sheet 7.

In the switch unit 101, the spring 4 is fixed inside the column portion 22 of the slider 2, and the conical spring 3 is interposed between the slider 2 and the housing 5, so that the slider 2 is engaged with the housing 5 so as to be slidable up and down. Thus, the slider 2, the conical spring 3, the spring 4, and the housing 5 included in the switch unit 101 are integrated. The conical spring 3 is deformed in accordance with the sliding of the slider 2 in the vertical direction.

The conical spring 3 is a spring formed by spirally winding a wire rod with a gap, and the diameter of the conical spring 3 in plan view is reduced from the lower portion of the conical spring 3 toward the upper portion thereof. The spring 4 is a cylindrical spring, and the diameter of the spring 4 in plan view is constant. The material of each of the conical spring 3 and the spring 4 is a conductive piano wire, hard steel wire, stainless steel, or the like. In the present embodiment, the spring constant of the spring 4 is larger than the spring constant of the conical spring 3.

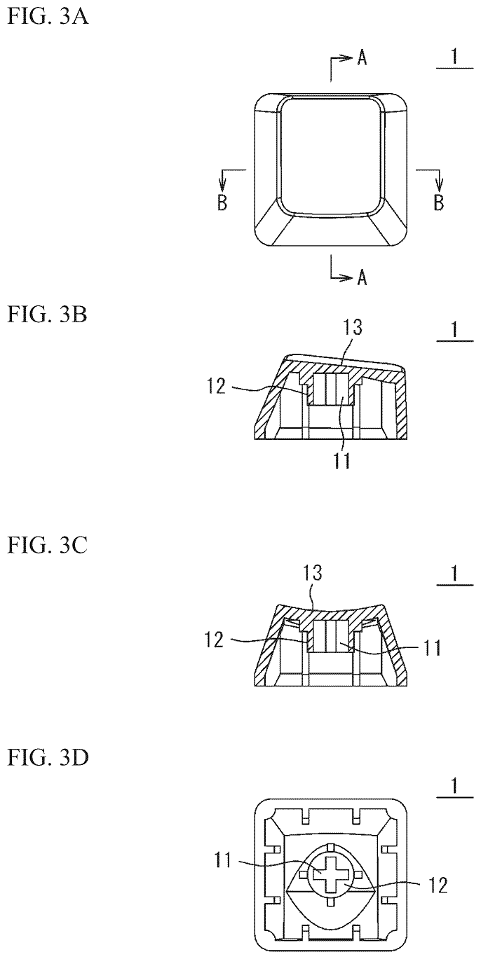

FIG. 3A is a plan view illustrating the front side of the key top 1, FIG. 3B is a cross-sectional view taken along a line A-A of FIG. 3A, FIG. 3C is a cross-sectional view taken along a line B-B of FIG. 3A, and FIG. 3D is a plan view illustrating the back side of the key top 1.

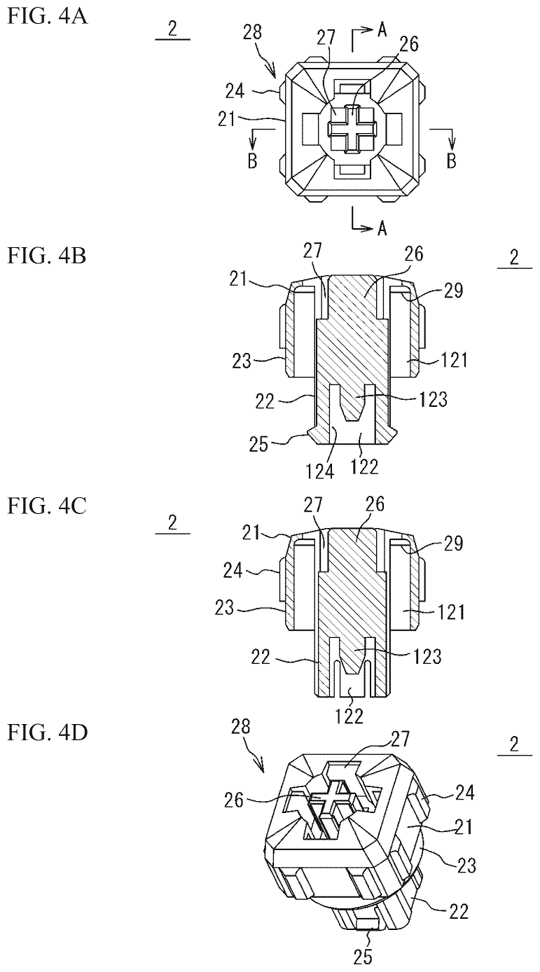

The key top 1 is formed by integral molding using a resin as a constituent material. As illustrated in FIGS. 3B to 3D, a protrusion 12 protruding downward from an upper surface 13 of the key top 1 is provided on the back surface of the key top 1. The protrusion 12 has a recess 11 for attachment to a cross-shaped protrusion 26 (see FIGS. 4A to 4D) of the slider 2.

FIG. 4A is a plan view of the slider 2 as viewed from above, FIG. 4B is a cross-sectional view taken along a line A-A of FIG. 4A, FIG. 4C is a cross-sectional view taken along a line B-B of FIG. 4A, and FIG. 4D is a perspective view of the slider 2.

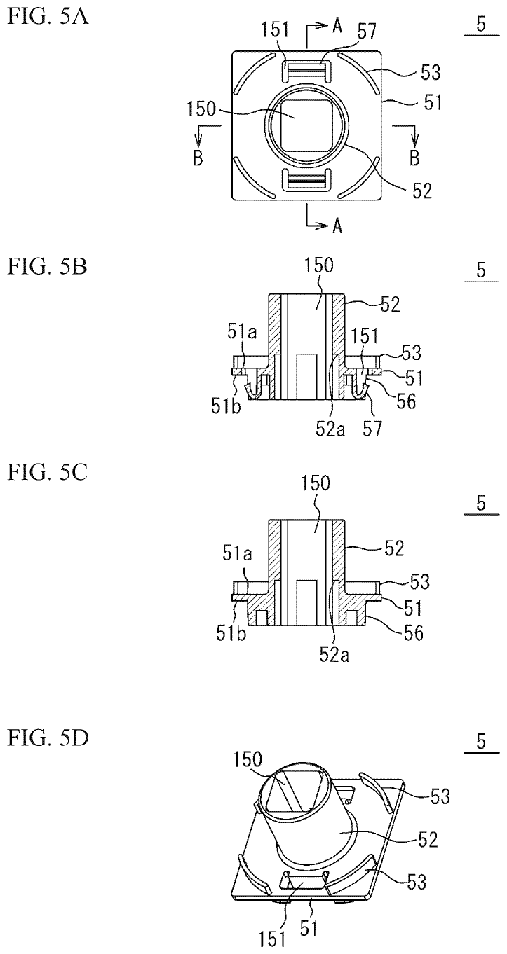

The slider 2 has a main body 21 and a column portion 22 extending from the main body 21 toward the housing 5. The column portion 22 is formed so as to have a substantially square cross-sectional shape. The column portion 22 has locking claws 25 for slidably locking the slider 2 to the housing 5. The locking claw 25 engages with a step 52a (see FIGS. 5B and 5C) on an inside wall of a guide 52 of the housing 5. The main body 21 has projections 24 formed on its outer periphery for engagement with the key top 1 and an outer peripheral surface 23 with which the upper portion of the conical spring 3 is in contact. Further, a space 121 for receiving the guide 52 of the housing 5 is provided between the main body 21 and the column portion 22. When the guide 52 of the housing 5 enters the space 121, a back surface 29 of the main body portion 21 faces the upper end of the guide 52 of the housing 5 (see FIGS. 6B and 6 C).

A ceiling portion 28, which is the upper end of the slider 2, includes a recess 27 for accommodating the protrusion 12 having the cross-shaped recess 11 of the key top 1, and the cross-shaped protrusion 26 for fitting into the cross-shaped recess 11 of the key top 1. The depth of the recess 27 is equal to or larger than the height of the protrusion 12 of the key top 1. Thus, even when the cross-shaped protrusion 26 is provided at the upper end of the slider 2, it is possible to suppress an increase in the overall height of the key switch assembly 100.

The column portion 22 has an opening 122 at the bottom, and a protrusion 123 for fixing the spring 4 is provided inside the column portion 22. A part of the spring 4 is inserted and fixed between an inner surface 124 of the column portion 22 and the protrusion 123.

The slider 2 and the housing 5 are formed of different materials having low friction at the time of contact. For example, the slider 2 is formed of a POM resin (polyacetal resin), and the housing 5 is formed of an ABS resin (thermoplastic resin formed by polymerizing three monomers of acrylonitrile, butadiene, and styrene). This is because if the slider 2 and the housing 5 are formed of the same material, the slider 2 bites into the guide 52 during sliding, and a stack occurs in which the key top 1 does not move. For this reason, the slider 2 and the housing 5 are formed of different materials having low friction at the time of contact. The materials of the slider 2 and the housing 5 are not limited to resins. In order to reduce friction at the time of contact, a process for reducing a friction coefficient may be performed on a portion where the slider 2 and the housing 5 come into contact with each other.

FIG. 5A is a plan view of the housing 5 as viewed from above, FIG. 5B is a cross-sectional view taken along a line A-A in FIG. 5A, FIG. 5C is a cross-sectional view taken along a line B-B in FIG. 5A, and FIG. 5D is a perspective view of the housing 5.

The housing 5 is a member that supports the slider 2 and the conical spring 3, and includes a square plate portion 51 that constitutes a base circuit board. The housing 5 includes the guide 52 (guide) that stands upright from the center of a front surface 51a of the plate portion 51 and guides the slider 2, a protrusion portion 53 that stands on the front surface 51a of the plate portion 51, is provided outside the guide 52 when the plate portion 51 is viewed from above, and guides the conical spring 3, and a leg portion 56 that stands on a back surface 51b of the plate portion 51 and is mountable to an opening 61 (see FIGS. 6B and 6C) of the switch panel 6. The leg portion 56 includes claw portions 57 that interpose the switch panel 6 between the claw portions 57 and the back surface 51b of the plate portion 51. When the leg portion 56 alone may be sufficient for fixing to the switch panel 6, the leg portion 56 does not necessarily have to include the claw portions 57. Openings 151 are provided at positions of the plate portion 51 above the claw portions 57. This allows the user to check from above whether the switch panel 6 is interposed between the claw portions 57 and the back surface 51b of the plate portion 51. The number of the claw portions 57 is not limited to two, and may be four.

A through hole 150 having a substantially rectangular cross section for inserting the column portion 22 of the slider 2 is formed at the center of the guide 52.

FIG. 6A is a plan view of the key switch assembly as viewed from above, FIG. 6B is a cross-sectional view taken along a line A-A of FIG. 6A, FIG. 6C is a cross-sectional view taken along a line B-B of FIG. 6A, and FIG. 6D is an enlarged view of a lower portion of the key switch assembly.

The key switch assembly 100 includes the switch unit 101 including the slider 2, the conical spring 3, the spring 4 and the housing 5, the key top 1 that is mounted on the switch unit 101 and is pressed downward, the switch panel 6 that is a positioning member for positioning the housing 5, the membrane sheet 7 disposed under the housing 5 and the switch panel 6, and the circuit board 8 disposed under the membrane sheet 7.

The membrane sheet 7 is provided with the electrical contacts 7a. The electrical contacts 7a are disposed below the housing 5 and the switch panel 6, and when a predetermined pressing force is applied from the spring 4 by pressing down the key top 1, the two electrical contacts 7a physically contact each other, and the electrical contacts 7a are closed. As illustrated in FIG. 6D, in a state before the key top 1 is depressed, that is, in a steady state, the air gap 41 is provided between the spring 4 and the membrane sheet 7. A distance of the air gap 41 is indicated by “d”.

The switch panel 6 is disposed on the membrane sheet 7 and the circuit board 8, and is fixed to the circuit board 8 by screws or the like (not illustrated) via spacers 62 provided below the switch panel 6. The shape of the opening 61 of the switch panel 6 is square in plan view, and when the leg portion 56 of the housing 5 is mounted to the opening 61, the opening 61 is covered with the plate portion 51 of the housing 5. A space 90 having a predetermined height is formed between the switch panel 6 and the membrane sheet 7 by the spacers 62.

In plan view, the area of the plate portion 51 is larger than the area of the opening 61 of the switch panel 6. Therefore, the plate portion 51 of the housing 5 is in contact with the peripheral portion of the opening 61 of the switch panel 6, and the leg portion 56 of the housing 5 can be mounted in the opening 61 of the switch panel 6. The housing 5 can be avoided from entirely sinking into the opening 61 of the switch panel 6.

If the space 90 having a predetermined height is formed at the height of the leg portion 56, the key switch assembly 100 can be configured without providing the switch panel 6 by attaching the lower portion of the housing 5 to the upper surface of the membrane sheet 7 with a double-sided tape or the like.

When the user presses the key top 1, the column portion 22 of the slider 2 slides with respect to the through hole 150 of the guide 52, and thus the slider 2 moves downward. The conical spring 3 is contracted by the movement of the slider 2. The spring 4 attached to the slider 2 is brought into contact with the membrane sheet 7 by the movement of the slider 2, and the membrane sheet 7 is pressed by the compression of the spring 4, so that the electrical contacts 7a are turned on.

When the user releases the finger from the key top 1, the slider 2 returns to an original position by the elastic force of the conical spring 3 and the spring 4. In the membrane sheet 7, the pressing force of the key top 1 is reduced and the electrical contacts 7a are turned off.

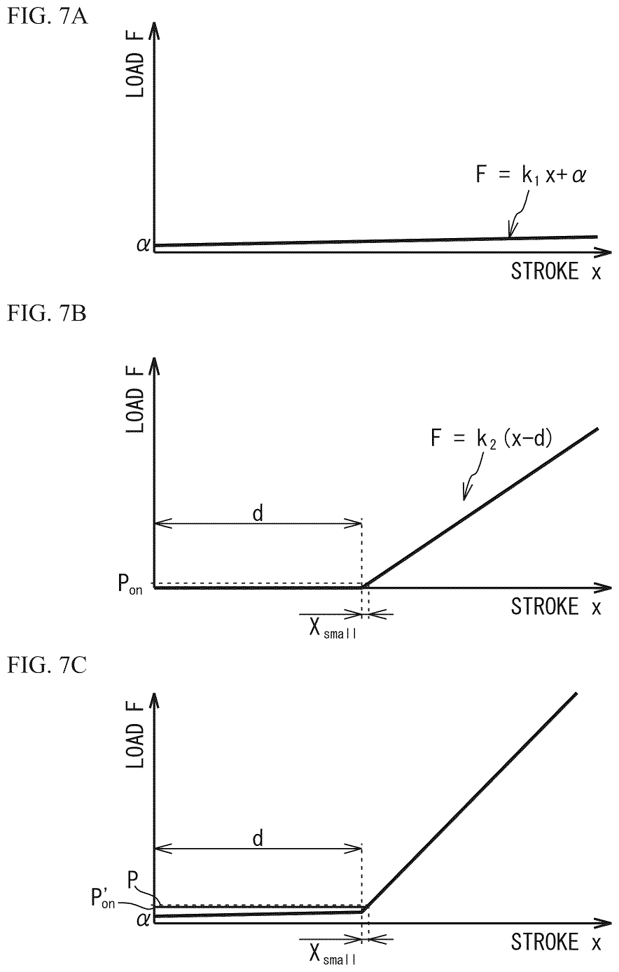

FIG. 7A is a diagram illustrating the depression characteristic of the conical spring 3, FIG. 7B is a diagram illustrating the depression characteristic of the spring 4, and FIG. 7C is a diagram illustrating the depression characteristic of the key switch assembly 100 in which the depression characteristics of the conical spring 3 and the spring 4 are combined. That is, the depression characteristic of the key switch assembly 100 illustrated in FIG. 7C is a combination of the depression characteristics illustrated in FIGS. 7A and 7B. Each of the horizontal axes in FIGS. 7A to 7C represents a stroke (i.e., depression amount) of the key top 1 and each of the vertical axes in FIGS. 7A to 7C represents a load (i.e., depression force or repulsive force).

In FIGS. 7A to 7C, an “x” indicates a distance of the stroke, and an “F” indicates a load. A distance “d” indicates a distance (first distance) of the air gap 41 between the spring 4 and the membrane sheet 7 in the steady state. A “k1” indicates the spring constant of the conical spring 3, and a “k2” indicates the spring constant of the spring 4. An “Xsmall” indicates a minute displacement (second distance) of the stroke. The Xsmall is slightly larger than a distance between the electrical contacts 7a in the membrane sheet 7 in a height direction. A “Pon” indicates a load at which the spring 4 alone turns on the electrical contacts 7a. A “P′on” (solid line) indicates a load that turns on the electrical contacts 7a when the depression characteristics of the conical spring 3 and the spring 4 are combined. A “P” (dotted line) indicates a load required to press the key top 1 by a distance “d+Xsmall”. An “a” represents an initial pressure. The initial pressure is a force with which the conical spring 3 pushes up the slider 2 so that a steady state can be maintained even in a state where the key top 1 is not pressed. A free length of the conical spring 3 is longer than the length of the conical spring 3 in FIGS. 6B and 6C, and the conical spring 3 is compressed in the process of assembling the switch unit 101, and the force corresponding to the compression amount corresponds to the initial pressure.

As illustrated in FIG. 7A, the depression characteristic of the conical spring 3 is a linear sensation with a relatively gentle slope. When the stroke x increases, the load F increases gently in proportion to the stroke x.

As illustrated in FIG. 7B, the depression characteristic of the spring 4 is a linear sensation with a steeper slope than that of the conical spring 3. When the stroke x increases, the load F rapidly increases in proportion to the stroke x. At this time, a multiplication value of k2 and Xsmall is larger than the load Pon. That is, k2·Xsmall>Pon is satisfied.

As illustrated in FIG. 7C, when the stroke is equal to or less than the distance d, the load (pressing force or repulsive force) F for pressing down the key top 1 satisfies Equation 1. When the stroke exceeds the distance d, the load F for pressing down the key top 1 satisfies Equation 2.

$$If x \leq d , F = k 1 \cdot x + α \qquad ( Equation 1 )$$

$$If x > d , F = k 1 \cdot x + k 2 \cdot ( x - d ) + α \qquad ( Equation 2 )$$

The load P when the key top 1 is depressed by the total distance of the distance d and the minute displacement Xsmall satisfies Expression 3.

$$P = k 1 \cdot ( d + Xsmall ) + k 2 \cdot Xsmall + α > {P}^{′} on \qquad ( Equation 3 )$$

That is, the load P when the key top 1 or the spring 4 is depressed by the total distance of the distance d and the minute displacement Xsmall is larger than the load P′on for turning on the electrical contacts 7a when the depression characteristics of the conical spring 3 and the spring 4 are combined.

When the stroke is equal to or less than the distance d, the load F for pressing down the key top 1 is affected only by the depression characteristic of the conical spring 3, and therefore, a light depressing sensation in which the repulsive force gently increases in proportion to the stroke can be realized. When the stroke exceeds the total distance of the distance d and the minute displacement Xsmall, the spring 4 is in contact with the membrane sheet 7, and the electrical contacts 7a of the membrane sheet 7 are turned on.

The spring 4 applies a force independent of the operating force to the membrane sheet 7. The spring constant of the spring 4 and the load P′on are set so that the load P when the spring 4 is depressed by the total distance of the distance d and the minute displacement Xsmall exceeds the load P′on, so that the electrical contacts 7a can be turned on substantially at the same time as the timing when the spring 4 is in contact with the membrane sheet 7. After the spring 4 is in contact with the membrane sheet 7, not only the initial pressure a and the repulsive force of the conical spring 3, but also the repulsive force of the spring 4 are added to the sensation, and thus the sensation felt by the user is a combined repulsive force of the initial pressure a, the conical spring 3, and the spring 4. That is, after the spring 4 is in contact with the membrane sheet 7, the spring constant changes to a spring constant of the spring 4 that is larger than the spring constant of the conical spring 3 and that cannot be pushed all the way to the stroke end unless the user consciously increases the load F. This enables the user to unconsciously stop applying the operating force for pressing down the key top 1, and to recognize the ON state of the electrical contacts 7a only by the sensation. Thus, the user can recognize the ON state of the electrical contacts 7a only by the sensation, due to the change from the spring constant of the conical spring 3 to the spring constant of the spring 4.

In the conventional key switch device with the linear sensation, the user cannot recognize that the electrical contacts of the key switch assembly are turned on only by the sensation without viewing the contents inputted on the operation screen, but in the key switch assembly 100 of the present embodiment, the user can recognize that the electrical contacts 7a are turned on only by the sensation.

Therefore, the user does not need to push the key top 1 to the stroke end, and thus does not need to apply a wasteful operating force to the key top 1. This can suppress accumulation of fatigue due to typing.

In the state before the key top 1 is depressed, that is, in the steady state, the distance D1 (see FIGS. 6B and 6C) between the back surface 29 of the main body 21 and the upper end of the guide 52 of the housing 5 is larger than the total distance of the distance d and the minute displacement Xsmall. Accordingly, even when the key top 1 or the spring 4 is pressed by the total distance of the distance d and the minute displacement Xsmall, the slider 2 can be suppressed from abutting against the guide 52 of the housing 5, and thus the reaction to the finger due to the abutment of the slider 2 against the guide 52 can be suppressed, and the fatigue can be reduced. Furthermore, since noise generated by contact between the slider 2 and the guide 52 can be suppressed, typing noise can be reduced.

In the present embodiment, since the sudden change from the spring constant of the conical spring 3 to the spring constant of the spring 4 is a feature, when the stroke is equal to or less than the distance d, it is necessary to have a very light pressing sensation. The spring constant of the conical spring 3 varies depending on the wire diameter, the number of turns, the inner diameter, and the like. In particular, when the wire diameter and the amount of expansion and contraction do not change, the spring constant can be reduced by increasing the number of turns of the conical spring 3.

In this embodiment, not the cylindrical spring like the spring 4 but the conical spring 3 is interposed between the slider 2 and the housing 5. When the number of turns of the cylindrical spring such as the spring 4 is increased, the coils come into contact with each other due to the amount of contraction, and the total length of the stroke is limited. In contrast, the conical spring 3 can avoid the contact between the coils of the conical spring 3, and thus can avoid the limitation on the stroke. In addition, when the height of the spring is limited, the conical spring 3 can increase the number of turns compared to the cylindrical spring such as the spring 4, and the load on each coil can be reduced when the number of turns is large, so that the keying life can be extended. Therefore, the conical spring 3 is adopted.

In the present embodiment, customization is possible by changing the conical spring 3 and the spring 4 to another conical spring 3 and another spring 4 having different lengths or spring constants. Further, since the distance d of the air gap 41 can be changed by changing the overall length of the spring 4, the ON position of the electrical contacts 7a can be changed. Since the spring 4 applies a force independent of the operating force to the membrane sheet 7, even if the ON position of the electrical contacts 7a is changed, the ON state of the electrical contacts 7a can be recognized by the change in the spring constant by setting the spring constant of the spring 4 and the load P′on so that the load P when the spring 4 is pressed by the total distance of the distance d and the minute displacement Xsmall exceeds the load P′on. Further, by changing the spring 4 to a spring having a larger spring constant, it is possible to increase the change in the load during the depression of the minute displacement Xsmall.

In the present embodiment, in order to enable the key top 1 to be started to be pressed with a lighter feel than that of the conventional key switch assembly with a lighter feel (for example, load 0.2N), to enable the load at the stroke end to exceed that of the conventional key switch assembly with a heavier feel (for example, load 0.8N), and to enable the user to clearly recognize the ON state of the electrical contacts 7a, the spring constant of the spring 4 is preferably set to be 5 times or more and 15 times or less the spring constant of the conical spring 3. If the spring constant of the spring 4 is less than 5 times the spring constant of the conical spring 3, it is not sufficient to allow the user to recognize the ON state of the electrical contacts 7a only by the sensation, and there is a possibility that the user depresses the key top 1 more than necessary and the slider 2 abuts against the guide 52. If the spring constant of the spring 4 is set to be 5 times or more of the spring constant of the conical spring 3, the final pressure of the conventional key switch assembly with a light sensation is exceeded, and the maximum load before click of the key switch assembly providing the click sensation can be exceeded. This is because, when the spring constant of the spring 4 exceeds 15 times the spring constant of the conical spring 3, the operating force for pressing down the spring 4 by the minute displacement Xsmall becomes excessive, and the user feels as if the slider 2 is striking the guide 52 or as if the distance to the stroke end is shortened, and there is a possibility that fatigue cannot be reduced.

Further, as illustrated in FIG. 7A, since the conical spring 3 alone is required to increase the load gently from the initial pressure to the final pressure, the final pressure is preferably set to be 2 to 3 times the initial pressure a. The final pressure is a force with which the conical spring 3 pushes up the slider 2 when the electrical contacts 7a are turned on.

Further, in the present embodiment, it is preferable that the load P when the spring 4 is pressed down by the total distance of the distance d and the minute displacement Xsmall is 8 times or more and 12 times or less the initial pressure a of the conical spring 3 alone. This is because, when the load P is less than 8 times the initial pressure a, it is insufficient to allow the user to recognize the ON state of the electrical contacts 7a only by the sensation, and when the load P exceeds 12 times the initial pressure a, the operating force for pressing down the spring 4 by the minute displacement Xsmall becomes excessive. Further, since the load P is 8 times or more and 12 times or less the initial pressure a, the operating force becomes a load that cannot fully press the key top 1 unless the user is conscious as the stroke end is approached.

The minute displacement Xsmall is larger than 0 mm and is equal to or less than ⅕ of the distance d of the air gap 41. If the minute displacement Xsmall exceeds ⅕ of the distance d of the air gap 41, a difference between the operating force when the spring 4 is in contact with the membrane sheet 7 and the operating force when the electrical contacts 7a are turned on increases, and the user may stop pressing down the key top 1 before the electrical contacts 7a are turned on, which may cause a failure to input. More preferably, the minute displacement Xsmall is larger than 0 mm and is equal to or less than 1/10 of the distance d. More preferably, the minute displacement Xsmall is larger than 0 mm and is equal to or less than 1/20 of the distance d. Since the minute displacement Xsmall is considerably smaller than the displacement d, the user can recognize the ON state of the electrical contacts 7a only by the sensation substantially at the same time as the timing when the spring 4 is in contact with the membrane sheet 7.

In the present embodiment, the conical spring 3 is used as the spring interposed between the slider 2 and the housing 5 from the viewpoint of the shape and the depression characteristic, but the shape of the spring interposed between the slider 2 and the housing 5 is not limited as long as the same characteristic as the conical spring 3 is obtained.

In the present embodiment, two springs (i.e., the conical spring 3 and the spring 4) are used as components for producing the sensation so that the ON state of the electrical contacts 7a can be recognized by the linear sensation. However, since it is possible to cause the user to recognize the ON state of the electrical contacts 7a by combining three or more components, the number of components for producing the sensation is not limited. For example, by replacing the conical spring 3 with two conical springs having different diameters, the number of components for producing the sensation is three in total. Further, by replacing the spring 4 with two springs having different diameters, the number of components for producing the sensation is three in total. Further, a protrusion member for pressing down the electrical contacts 7a of the membrane sheet 7 may be provided under the spring 4, and the component for producing the sensation may be constituted by three components of the conical spring 3, the spring 4, and the protrusion member.

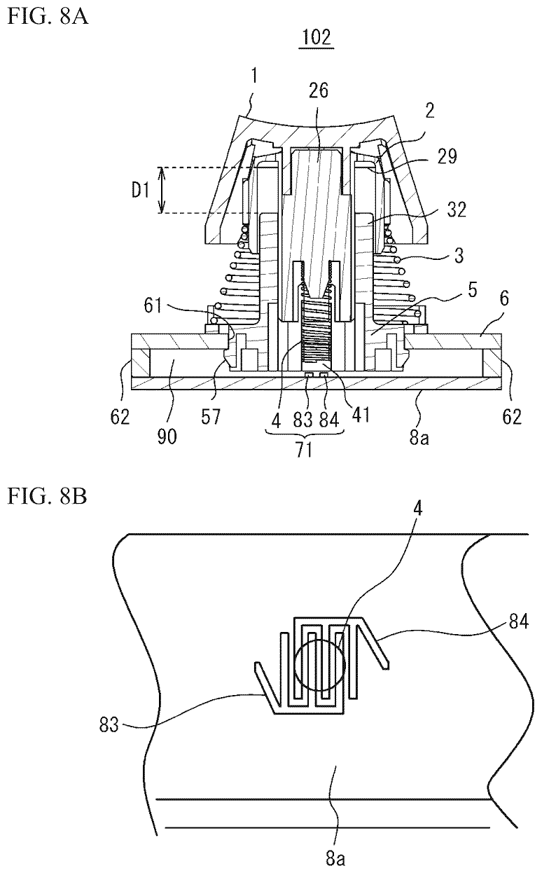

In the present embodiment, the membrane sheet 7 including the electrical contacts 7a, and the circuit board 8 are used. A printed circuit board 8a having a first contact 83 and a second contact 84 may be used instead of the membrane sheet 7 and the circuit board 8. FIG. 8A is a cross-sectional view of a key switch assembly 102 having the printed circuit board 8a. FIG. 8B is a plan view illustrating a positional relationship between the spring 4, and the first contact 83 and the second contact 84. In this case, the first contact 83 and the second contact 84 provided adjacent to each other on the surface of the printed circuit board 8a are disposed below the spring 4 via the air gap 41. The spring 4 is brought into contact with the first contact 83 and the second contact 84 provided on the printed circuit board 8a by the sliding of the slider 2, and the first contact 83 and the second contact 84 are electrically short-circuited through the spring 4. Thus, the spring 4, the first contact 83, and the second contact 84 constitute an electrical contact 71. This eliminates the need for the membrane sheet 7, thereby reducing the number of components.

When the membrane sheet 7 and the circuit board 8 are used, the electrical contacts 7a are not turned on only by the springs 4 contacting the membrane sheet 7, and the load P when the springs 4 are pressed down by the total length of the distance d and the minute displacement Xsmall needs to exceed the load P′on. Therefore, although there is a slight time lag between the spring 4 contacting the membrane sheet 7 and the electrical contacts 7a being on, the time lag can be ignored from the magnitude of the force of the spring 4.

On the other hand, when the printed circuit board 8a is used, the spring 4 attached to the slider 2 is in contact with the first contact 83 and the second contact 84 provided on the printed circuit board 8a, so that a current can flow from the first contact 83 to the second contact 84 or from the second contact 84 to the first contact 83, and thus the electrical contacts 71 can be turned on at the same time as the contact. Further, after the spring 4 is in contact with the first contact 83 and the second contact 84, the repulsive force increases due to the spring constant of the spring 4, and thus the user can recognize the ON state of the electrical contact 71 only by the sensation.

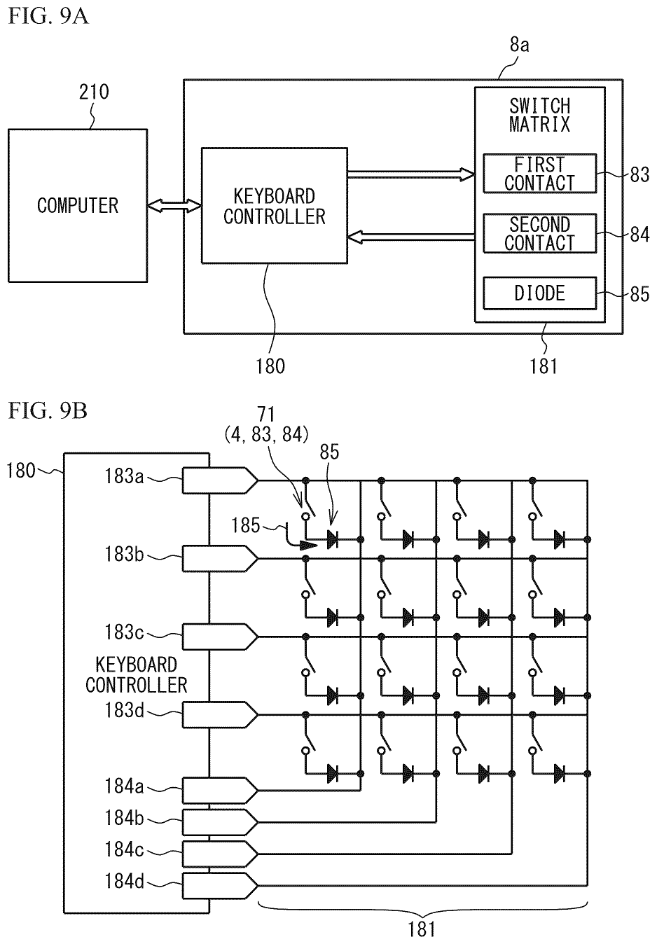

FIG. 9A is a block diagram illustrating a connection relation between the printed circuit board 8a and a computer 210, and FIG. 9B is a circuit diagram of a keyboard controller 180 and a switch matrix 181 which are included in the printed circuit board 8a.

As illustrated in FIG. 9A, the printed circuit board 8a includes the keyboard controller 180 and the switch matrix 181 and is connected to the computer 210 which is an external device. The keyboard controller 180 is configured by an IC (integrated circuit) or a microcomputer, recognizes a pressed key, and transmits a key code corresponding to the pressed key to the computer 210. The keyboard controller 180 returns information on the type of the keyboard 200 to the computer 210 in response to a request from the computer 210. The switch matrix 181 includes the first contact 83, the second contact 84 and a diode 85 for each switch unit 101.

As illustrated in FIG. 9B, the keyboard controller 180 includes output ports 183a to 183d for outputting driving currents to the switch matrix 181, and reception ports 184a to 184d for receiving currents corresponding to the on or off state of the electrical contacts 71 from the switch matrix 181. The number of output ports and the number of reception ports are not limited to the example of FIG. 9B. For example, when the electrical contacts 71 illustrated are turned on, the drive current from the output port 183a flows along a path 185 through the diode 85 to the reception port 184a. Even if a plurality of electric contacts are simultaneously turned on, the sneak current is avoided by the diode 85, so that the ghost input can be avoided.

The keyboard 200 corresponds to an N-key rollover (N=an integer of 2 or more) in which, when a plurality of keys are pressed at the same time, all key inputs are recognized according to the order of pressing.

As described above, according to the present embodiment, the key switch assembly 100 includes the slider 2 that is slidable by pressing the key top 1, the housing 5 that guides the slider 2, the conical spring 3 that is provided between the slider 2 and the housing 5 and generates a repulsive force against a force pressing the key top 1, the spring 4 that is mounted on the slider 2 and opens and closes the electrical contacts 7a, and the electrical contacts 7a or 71 that are arranged to have the air gap 41 between the spring 4 and the electrical contacts 7a or 71 in a state before the key top 1 is pressed, and are opened and closed by the spring 4 in accordance with the sliding of the slider 2. The spring constant of the spring 4 is larger than the spring constant of the conical spring 3. This provides the user with a linear sensation, which is a key sensation without a click sensation, and allows the user to recognize the ON state of the electrical contacts 7a only by the sensation. Further, since the user is made to recognize the ON state of the electrical contacts 7a only by the sensation, it is possible to prevent the user from failing to input.

The spring provided between the slider 2 and the housing 5 is the conical spring 3. This makes it possible to avoid contact between the coils even when the number of turns of the spring is increased, and thus to avoid limitation on the stroke. The load on each coil can be reduced as the number of turns is large, so that the keying life of the conical spring can be extended.

The spring constant of the spring 4 is 5 times or more and 15 times or less the spring constant of the conical spring 3. As a result, the repulsive force increases immediately after the spring 4 is in contact with the membrane sheet 7, and thus the user can recognize the ON state of the electrical contacts 7a or 71 only by the sensation.

According to the present embodiment, the key switch assembly 100 includes the slider 2 that is slidable by pressing the key top 1, the housing 5 having the guide 52 that guides the slider 2, the conical spring 3 that is provided between the slider 2 and the housing 5 and generates the repulsive force against the force pressing the key top 1, the spring 4 that is mounted on the slider 2 and opens and closes the electrical contacts 71 in accordance with sliding of the slider 2, and the printed circuit board 8a that has the first contacts 83 and the second contacts 84 constituting the electrical contacts 71, has the air gap 41 between the printed circuit board 8a and the spring 4, and allows the spring 4 to contact the first contacts 83 and the second contacts 84 in accordance with sliding of the slider 2. The spring constant of the spring 4 is larger than the spring constant of the conical spring 3. This provides the user with a linear sensation, which is a key sensation without a click sensation, and allows the user to recognize the ON state of the electrical contact 71 only by the sensation. In particular, after the spring 4 is in contact with the first contact 83 and the second contact 84, the repulsive force increases due to the spring constant of the spring 4, and thus the user can recognize the ON state of the electrical contact 71 only by the sensation. Further, since the user is made to recognize the ON state of the electrical contact 71 only by the sensation, it is possible to prevent the user from failing to input. Further, since the membrane sheet 7 is not required, the number of components can be reduced.

All examples and conditional language provided herein are intended for the purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A key switch assembly comprising:
a sliding member that is slidable by pressing of an operation member;
a support member having a guide that guides the sliding member;
a first elastic member provided between the sliding member and the support member, the first elastic member generating a repulsive force against a force pressing the operation member;
a second elastic member that is attached to the sliding member; and
an electrical contact disposed so as to have an air gap between the electrical contact and the second elastic member in a state before the operation member is pressed, the electrical contact being opened and closed by the second elastic member in accordance with sliding of the sliding member;
wherein a spring constant of the second elastic member is larger than a spring constant of the first elastic member.

2. The key switch assembly according to claim 1, wherein
the first elastic member is a conical spring.

3. The key switch assembly according to claim 1, wherein
the spring constant of the second elastic member is five times or more the spring constant of the first elastic member.

4. The key switch assembly according to claim 1, further comprising:
a membrane sheet that includes the electrical contact and is pressed down by the second elastic member,
wherein the electrical contact is closed when the operation member is pressed by a total distance of a first distance and a second distance, the first distance being a distance of the air gap, the second distance being smaller than the first distance.

5. The key switch assembly according to claim 4, wherein
the second length is greater than the 0 mm and less than or equal to one fifth of the first length.

6. The key switch assembly according to claim 4, wherein
the sliding member includes a main body, and a column portion extending from the main body toward the support member, and
in a state before the operation member is pressed, a distance between the back surface of the main body and an upper end of the guide is larger than a total distance of the first distance and the second distance.

7. The key switch assembly according to claim 1, further comprising:
a printed circuit board on which a first contact and a second contact constituting the electrical contact are disposed adjacent to each other,
wherein the electrical contact is closed by short-circuiting between the first contact and the second contact by the second elastic member in accordance with the sliding of the sliding member.

8. A keyboard comprising a plurality of key switch assemblies according to claim 1.

9. A console device comprising the keyboard according to claim 8.
